(19) United States
(12) Patent Application Publication
(10) Pub. No.: US 2018/0101777 A1
(43) Pub. Date: Apr. 12, 2018

(54) EM Oracle

(71) Applicant: Anuthep Benja-Athon, New York, NY (US)

(72) Inventor: Anuthep Benja-Athon, New York, NY (US)

(21) Appl. No.: 15/292,080

(22) Filed: Oct. 12, 2016

(51) Int. Cl. G06N 5/04; G06N 99/00; H04L 29/08

(52) U.S. Cl. CPC G06N 5/04; H04L 67/10; G06N 99/005

(57) ABSTRACT

The EM Oracle having heuristics networked repositories for collective learning to reader and improve abiotic intelligence capable of rendering abiotic decisions based on rendered heuristics and logics being rendered and improved by collective learning in and among heuristics networked repositories. The abiotic decisions render and display dominant, and prevalent heuristics and logics in said touchscreens as targets of modifications to modify fates and create abiotic selection to revolutionize evolution.

This is a continuation-in-part of application Ser. No. 14/992,773 entitled the Creation of Abiotic-Biotic Civilization filed Jan. 11, 2016, Ser. No. 14/606,956 entitled Billion Recounts of Events Ahead of Days filed Jan. 27, 2015.

### FIELD OF THE INVENTION

Networks for rendering abiotic intelligence to revolutionize evolution.

### BACKGROUND OF THE INVENTION

Evolution is tar from achieving its goal of evolving perfect organisms; consequently, diseases, disorders and short life spans abound. Evolution has neither heretofore envisioned nor accounted for its course and natural selection being modified and changed by the present invention also known as the EM Oracle. In other words, the universe's natural selection is being programmed, engineered and modified by the EM Oracle which is creating the Abiotic Selection (AbS)-networked-communication devices for supplanting natural selection before time allot by the universe. AbS is being inserted in real-time into evolution by and among said networked repositories being instructed by the adaptable and expanding innovative computer programs, in particular, billions of smartphones.

The em consequences on lives and non-living are infinite beyond imagination. They will have much less to no diseases, disorders, failures, pain and suffering. The EM Oracle has already begun to rapidly achieve same now and in the future.

### SUMMARY OF THE INVENTION

The present invention created networks of servers and mobile communication devices to modify people's fates and revolutionize evolution at the rate immensely faster than that of the universe. The EM Oracle comprising networks for collective learning to render abiotic decisions capable of abiotic selection and modifying fates to revolutionize evolution based on heuristics and logics rendered in the networks wherein the abiotic decisions render networks-rendered relations of inherent heuristic algorithms and logics inherent in and among networks-rendered relations of adaptable heuristic bits of relational data in and among adaptable heuristic compilations of relational data, in the adaptable heuristic compilations of relational databases in memories henceforth rendered heuristics and logics in and among said heuristic networked servers and devices repositories, rendered heuristics and logics for marking and displaying rendered dominant and prevalent heuristics and logics in and among servers and mobile communication devices.

To modify people's fates, people are able to render, view and interact with said rendered dominant and prevalent heuristics and logics in the touchsceens and viewing screens. Targeting said dominant and prevalent heuristics and logics, the EM Oracle rendering and guiding physical, biological, genetic and chemical interventions, therapeutics and engineerings and predicting and extrapolating the products, events and sequelae as consequences of the interventions, therapeutics and engineerings to render abiotic selection to improve people's lives and longevity thus revolutionizing evolution.

### DESCRIPTION OF THE PREFERRED EMBODIMENTS

The EM Oracle capable of collective learning for creating abiotic intelligence—in lieu of “artificial” intelligence—to render decisions for modifying and controlling fates and revolutionizing evolution. It comprises networks of heuristic networked servers and devices repositories capable of collective learning for rendering, sharing and improving the Heuristics Algorithms Locating System for rendering and improving adaptable abiotic intelligence known infra as rendered heuristics and logics in and among said heuristic networked servers and devices repositories. Said rendered heuristics and logics networked said heuristic networked servers and devices repositories to create the EM Oracle.

Said networks of heuristic networked servers and devices repositories in and among networked servers and mobile communication devices such as, but not limited to, smartphones and laptops and desktops having networked repositories comprising memories and processor units, repository and device identifications, said touchscreens and viewing screens, cameras, microphones, speech recognition software and apps, said networked repositories comprising processor units for processing and expanding said rendered heuristics and logics, relations and compilations and said data and networks being instructed and guided by the innovative computer programs and said memories for storing software including said innovative computer programs, software and databases including said rendered heuristics and logics and data, commercial operating systems for managing said networked servers and devices, the Internet, commercial networking means, security means and software including web browsers.

The present invention created the EM Oracle by creating said innovative computer programs to attach to said networked servers and devices repositories wherein, among other functions infra, said computer programs transformed said networked servers and devices repositories into heuristic networked servers and devices repositories by creating a means for rendering and enlarging said networks of heuristic networked servers and devices repositories thus said collective learning for creating and improving said abiotic intelligence. Said means for rendering and enlarging comprising a means for rendering and improving said adaptable abiotic intelligence.

Furthermore, said innovative computer programs for rendering said heuristic networks, basic collective learning, HALS, Thesaurus, heuristics-logics synthesizer, means infra, EM oracle. Said computer programs for rendering a plurality of apps infra, said apps for executing said innovative computer programs in and among said networks of heuristic networked servers and devices repositories.

By networking billions of repositories of said smartphones, laptops, servers and desktops related to billions of people including millions of physicians and scientists, engineers, etc. using the EM Oracle to render and input into said heuristic networked repositories in which said rendered heuristics and logics are shared and used in and among said heuristic networked servers and devices repositories. Said perpetual processes render and improve said basic collective learning and HALS.

Said computer programs also rendering apps in said touchscreens and viewing screens. Said apps for activating said innovative computer programs to rendering diverse and different orders and organizations of diverse and different heuristic compilations of relational data including images and videos comprising relations of heuristic bits of relational data represented herein as relational field*_n, specialty*_n-, diagnosis*_n-, finding*_n, causation*_n, temporal*_n-, duration*_n- and category*_n- and repository*, server* or device*-identification*_n-specific data wherein each of heuristic bits of relational data is endowed with inherent heuristics and logics. Said processor units identify and get said immense quantity of relations and compilations from said rendered heuristics and logics in and among said heuristic networked servers and devices repositories, where * connotes individual distinct terms, n=1, 2, 3 . . . , very large number.

Said field*_n and specialty*_n are such subjects, topics and headings as, but not limited to, people and animals healthcare, health, medicine and surgery, behaviors, perceptions, pharmaceuticals, accidents, traumas, chronic cares, longevity, resources and assets, capitals and wealth, finance, productivities, equities, insurance, investments, retirements, pensions and decision makings. Said field*_n and specialty*_n also pertain to nonliving objects and things and nature with relevant subjects, topics and headings, where * connotes individual distinct subjects, topics and headings, n=1, 2, 3 . . . , 1,000,000's.

Said innovative computer programs created the professional and technical Terminologies-Lay Terminologies Thesaurus software for instructing said networked repositories what to and how to constitute and render relational professional and technical terminologies-lay terminologies analogies such as, but not limited to, English and non-English data in said rendered heuristics and logics in said touchscreens and viewing screens and in said memories. In other words, associating with data in said interactive touch-enabled and touch-responsive rendered heuristics and logics, said Thesaurus serves as the languages translator of said data in and among said touchscreens and viewing screens wherein said data are displayed in languages, images and videos comprehensible and useable by and among lay people and professional people. Said innovative computer programs applies said Thesaurus in and among relevant networked servers and devices repositories.

The Basic Collective Learning

Said means for rendering and improving said adaptable abiotic intelligence comprises said innovative computer programs rendering a plurality of interactive touch-enabled and touch-responsive scrolling multi-windows in and among said touchscreens and viewing screens in which a plurality of interactive electronic templates for rendering a plurality of interactive touch-enabled, touch-responsive, expandable, retractable, highlightable scrolling tabs, list, tiles and sub-tiles, folders, files and sub-files, images, icons such as, but not limited to, assortment of hamburger icons, and videos each of which comprising or associating with a plurality of adaptable heuristic compilations of relational data henceforth interactive templates wherein each of said compilations comprising interactive touch-enabled, touch-responsive, expandable, retractable, highlightable scrolling comprising a plurality of interactive touch-enabled, touch-responsive, collapsible, expandable and retractable drop-downs and pop-ups comprising interactive touch-enabled, touch-responsive, collapsible, expandable and retractable highlightable rendered heuristics and logics henceforth interactive icons and images.

One of the preferred embodiments of said multi-windows can be seen in the iPhones, click Safari, then click the double-square icon in the right corner of the page.

Said interactive templates—said heuristic networked servers and devices repositories associating said Thesaurus and heuristics-logics synthesizer with said renderings in said interactive templates in said touchscreens and viewing screens, said Thesaurus and heuristics-logics synthesizer for editing and modifying said heuristic compilations of relational data in said interactive templates, said heuristic compilations of relational data being gotten by said processor units from said rendered heuristics and logics in said memories. In other words, Thesaurus and heuristics-logics synthesizer rendering relations of heuristic bits of relational data in and among said interactive templates to render, adapt and improve said rendered heuristics and data—abiotic intelligence of the EM Oracle.

Associating said Thesaurus and heuristics-logics synthesizer with said renderings in and among said touchscreens and viewing screens, said Thesaurus and heuristics-logics synthesizer for editing and modifying relations of said heuristic compilations of relational data in said interactive templates, said heuristic compilations of relational data being rendered in said interactive templates are scanned and analyzed by said processor units and are related to said rendered heuristics and logics in said memories. Simultaneously, said computer programs instruct said processor units to identify, mark and get said dominant and prevalent heuristics and logics in said rendered heuristics and logics to display in and among said touchscreens and viewing screens.

Similarly, said computer programs instruct said processor units to scan, analyze queries comprising bits of data and bits of relational data in said interactive templates in said networks and to apply said processes to said queries to achieve supra. Simultaneously, said computer programs instruct said processor units to identify, mark and get said dominant and prevalent heuristics and logics in said rendered heuristics and logics to display in and among said touchscreens and viewing screens.

Said computer programs instruct said processor units-to render and guide said rendered and stored physical biological, genetic and chemical interventions, therapeutics and engineerings in said memories targeting said rendered dominant and prevalent heuristics and logics based on said relations of said renderings in said rendered heuristics and logics and, simultaneously, to predict and extrapolate rendered and stored products, events and sequelae as consequences of said interventions, therapeutics and engineerings in said memories to modify and control fates and to render abiotic selection to revolutionize evolution.

HALS—the Collective Learning

Said basic collective learning created and continues to improve and expand the present invention. HALS comprising said abiotic creator associating with said Thesaurus and heuristics-logics synthesizer in and among said touchscreens and viewing screens of said heuristic networked servers and devices is the essence of the EM Oracle.

For rendering and improving the collective learning for creating abiotic intelligence to render decisions is created by EM Oracle using said computer programs to create and improve HALS incorporating said basic collective learning, Thesaurus and heuristics-logics synthesizer for rendering and improving said rendered heuristics and logics the abiotic brain of the EM Oracle. Said heuristic networked repositories of the EM Oracle use HALS—the collective learning to render and improve said adaptable abiotic intelligence in and among heuristic networked servers and devices repositories.

In and among said touchscreens and viewing screens of said heuristic networked servers and devices, HALS serves as the collective learning to rapidly and instantly create and improve abiotic intelligence to render and improve said decisions for modifying and controlling fates and revolutionizing evolution.

One of the preferred embodiments of HALS and its innovative rendered heuristics and logics creator henceforth the abiotic creator are well described in claims 4, 12 and 17 herein the Claims of the Present Invention.

In a nutshell, the rendering and improving of the collective learning are effected by HALS associating relevant rendered heuristics and logics with corresponding abiotic creator associating with said Thesaurus and heuristics-logics synthesizer in and among said touchscreens and viewing screens. Said Thesaurus and heuristics-logics synthesizer associating with said interactive tree traversals and interactive highlights in and among said touchscreens and viewing screens, said heuristics-logics synthesizer to modify said dominant and prevalent relations and compilations associating with said interactive tree traversals and interactive highlights by said processor units modifying and editing said dominant and prevalent relations and compilations in and among said touchscreens and viewing screens based on the editions and modifications of said heuristic compilations of relational data associating with editions and modifications said interactive tree traversals and interactive highlights being caused by the drag and drop, scroll, undo, cut, copy, paste, delete, find, find next, search, replace, go to, select functions of said heuristics-logics synthesizers.

Four examples of tree traversals and some related functions can be viewed at http://www.jqueryrain.com/?6N59fliE, http://www.jqueryrain.com/?Nw62xmH1, http://www.jqueryrain.com/?Nw62xmH1, and http://bl.ocks.org/mbostock/4339083.

Moreover, a collaboration of said interactive tree traversals and said interactive highlights with a plurality of multi-dimensional continua and sequences of assortment of interactive touch-enabled, touch-responsive, collapsible, expandable, retractable and highlightable electronic interactive icons and images, tabs, list, tiles and sub-tiles, folders, files and sub-files, images, icons and videos in said touchscreens and viewing screens henceforth interactive icons and images, said apps for activating said innovative computer programs to render queries in said means for rendering and improving said adaptable abiotic intelligence, said processor units for scanning, analyzing and relating said queries with said rendered heuristics and logics in said memories in and among said heuristic networked servers and devices repositories, said processor units for applying rendered heuristics and logics to identify, mark and get dominant and prevalent heuristics and logics related to said queries in said rendered heuristics and logics, said processor units for displaying highlighted interactive icons and images in and among said multi-dimensional continua and sequences representing coincidences of scanned, analyzed and related individual heuristic bits of relational data, heuristic compilations of relational data and related heuristics and logics in said queries with said same, similar, related and linked rendered heuristics and logics in said memories henceforth interactive highlights;

Said heuristics-logics synthesizer to modify said dominant and prevalent relations and compilations associating with said interactive tree traversals, interactive icons and images and both interactive highlights in said two paragraphs by said processor units modifying and editing said dominant and prevalent relations and compilations in and among said touchscreens and viewing screens based on the editions and modifications of said heuristic compilations of relational data associating with editions and modifications said interactive tree traversals, interactive icons and images and both interactive highlights being caused by the drag and drop, scroll, undo, cut, copy, paste, delete, find, find next, search, replace, go to, select functions of said heuristics-logics synthesizers in and among said interactive tree traversals, interactive icons and images and both interactive highlights in and among said touchscreens and viewing screens.

Additionally, collaborating with said heuristics-logics synthesizer in said basic collective learning and HALS, said innovative computer programs for instructing said networked repositories to use commercial speech recognition technologies and software for speech recognizing voice comprising said bits of relational data in conjunction, coordination and synchrony with said applications of said functions of said heuristics-logics synthesizer.

Said EM Oracle for rendering and guiding physical, biological, genetic and chemical interventions, therapeutics and engineerings targeting said dominant and prevalent relations and compilations and for predicting and extrapolating products, events and sequelae as consequences of said interventions, therapeutics and engineerings and for modifying and controlling fates to render abiotic selection to revolutionize evolution. One of the preferred embodiments is well described in claims 7, 8,14, 15, 19 and 20 herein the Claims of the Present Invention.

In a nutshell, said processor units for rendering relational, data on physical, biological, genetic and chemical interventions, therapeutics and engineerings and related products, events and sequelae as consequences and relations and compilations in said rendered heuristics and logics in said databases In said memories. With reference to said people and animal, for example, said category*_n- comprise healthcare and health categories of demographics, chief complaints, injuries, symptoms, signs, review of systems, physical examinations and findings, differential diagnoses, laboratory, test, pathology, diagnostics, measurements, pharmaceuticals, said physical interventions such as, but not limited to, surgeries, biological interventions such as, but not limited to, environmental changes and adaptations, genetic interventions such as, but not limited to, gene editings, individual, groups or bits of sequences of amino acids of chromosomes associating with said rendered heuristics and logics, etc. and chemical interventions such as, but not limited to, pharmaceuticals, chemotherapy, radiation therapy, therapeutics and engineerings and related products, events and sequelae as consequences genetic data and engineerings. For example, genetic and engineerings of genetic materials in people and animals in the discoveries of diseases and disorders and their treatments such as, but not limited to, gene editings, etc. Said category*_n- also pertain to inanimated objects and things and nature with relevant categories pertained to said inanimated objects and things.

Although several of the preferred embodiments of said abiotic creator has been described, it will be appreciated by and obvious to those skilled in the art and science that adaptations, variations and derivatives of said embodiments are and will be made and achieved to achieve the objectives of the invention without departing from the spirit and scope of the specification of the present invention.

Although various preferred embodiments of the present invention have been described, it will be appreciated by and obvious to those skilled in the art and science that adaptations, variations and derivatives of said embodiments are and will be made and achieved for people, animals and machines and objects without departing from the spirit and scope of the specification of the present invention.

1. The EM Oracle having adaptable abiotic intelligence for rendering abiotic decisions to render abiotic selection in networks, the EM oracle comprising said networks of heuristic networked servers and devices repositories for rendering and improving collective learning being rendered and improved by the Heuristics Algorithms Locating System, the EM Oracle for rendering and improving networks-rendered relations of inherent heuristics algorithms and logics inherent in and among networks-rendered relations of adaptable heuristic bits of relational data including images and videos in and among adaptable heuristic compilations of relational data including images and videos in the adaptable heuristic compilations of relational databases in memories henceforth rendered heuristics and logics in and among said heuristic networked servers and devices repositories;, the EM Oracle having a means for rendering and improving said adaptable abiotic intelligence and networks having the Thesaurus and the heuristics-logics synthesizer, the EM Oracle for rendering said abiotic decisions to identify, mark, get and display dominant and prevalent heuristics and logics based on rendered heuristics and logics in and among touchscreens and viewing screens and in said memories, for rendering and guiding physical, biological, genetic and chemical interventions, therapeutics and engineerings targeting said marked and displayed relations and compilations, for predicting and extrapolating the products, consequences, sequelae, preventions as consequences of said interventions, therapeutics and engineerings and for modifying and controlling fates to render said abiotic selection to revolutionize evolution, said EM Oracle comprises:
said networked servers and devices comprise networked servers, smartphones, laptops and desktops having networked repositories identifications, said touchscreens and viewing screens, cameras, microphones, speech recognition software and apps, said networked repositories: comprising processor units for processing and expanding said rendered heuristics and logics, relations and compilations and said data and networks being instructed and guided by the innovative computer programs and said memories for storing software including said innovative computer programs, software and databases including said rendered heuristics and logics and data, commercial operating systems for managing said networked servers and devices, the Internet, commercial networking means, security means and software including web browsers;
a means for rendering said networks of heuristic networked servers repositories and networked desktops and mobile communication devices repositories henceforth said heuristic networked servers and devices repositories:
a basic collective learning for rendering and improving said adaptable abiotic intelligence for rendering abiotic decisions;
said Heuristics Algorithms Locating System henceforth HALS—the collective learning for rendering and improving said abiotic intelligence in and among said networks of heuristic networked servers and devices repositories;
said HALS having said basic collective learning and the rendered heuristics and logics creator henceforth the abiotic creator endowed with said Thesaurus and heuristics-logics synthesizer for rendering and expanding said rendered heuristics and logics and for rendering and expanding said adaptable abiotic intelligence and networks to improve said collective learning;
said rendered heuristics and logics for dictating and guiding the EM Oracle to render relations of bits of data and relations bits of relational data selected from a plurality of interactive touch-enabled and touch-responsive relations of heuristic bits of relational data in and among a plurality of heuristic compilations of relational data in interactive drop-downs and pop-ups in said touchscreens and viewing screens, said renderings for improving rendered heuristics and logics and HALS in said touchscreens and viewing screens and in said adaptable heuristic compilations are scanned and analyzed and related to improve said rendered heuristics and logics in said adaptable heuristic compilations by said processor units being instructed by said computer programs;
said rendered heuristics and logics for dictating and guiding the EM Oracle to render said rendered heuristics and logics in said means for rendering and improving rendered heuristics and logics and HALS in said touchscreens and viewing screens and in said adaptable heuristic compilations in said memories;
said rendered heuristics and logics for dictating and guiding the EM Oracle to render said bits of relational data and relations of bits of relational data in and among adaptable heuristic compilations of relational data in said means for rendering and improving said adaptable abiotic intelligence;
said rendered heuristics and logics for dictating and guiding the EM Oracle to render queries comprising bits of relational data and relations of bits of relational data in said means for rendering and improving said adaptable abiotic intelligence;
said processor units for rendering relational data on physical, biological, genetic and chemical interventions, therapeutics and engineerings and related products, events and sequelae as consequences and relations and compilations in said rendered heuristics and logics in said databases in said memories;
said rendered heuristics and logics for dictating and guiding said processor units, said processor units for scanning, analyzing and relating said renderings to said rendered heuristics and logics in said memories in and among said heuristic networked servers and devices repositories and said processor units for identifying, marking and getting dominant and prevalent heuristics and logics in said rendered heuristics and logics to display in said touchscreens and viewing screens, said processor units for rendering and guiding said physical, biological, genetic and chemical interventions, therapeutics and engineerings rendered and stored in said memories targeting said rendered dominant and prevalent heuristics and logics based on said relations of said renderings in said rendered heuristics and logics and, simultaneously, to predict and extrapolate the products, events and sequelae as consequences of said interventions, therapeutics and engineerings rendered and stored in said memories and modifying and controlling fates to render abiotic selection to revolutionize evolution;
said innovative computer programs for rendering said heuristic networks, basic collective learning, HALS, Thesaurus, heuristics-logics synthesizer, means, EM oracle;
said innovative computer programs for rendering a plurality of apps, said apps for executing said innovative computer programs in and among said networks of heuristic networked servers and devices repositories;
millions of said networked heuristic servers and devices repositories in said networks; and
billions of said networked heuristic servers and devices repositories in said networks.

2. In EM Oracle according to claim 1 wherein said means for rendering said networks of heuristic networked servers and devices repositories, said means comprises:
said basic collective learning;
HALS;
said EM Oracle for rendering and improving networks-rendered heuristics and logics; millions of said heuristic networked servers and devices repositories for rendering and improving networks-rendered heuristics and logics in said networks; and billions of said heuristic networked servers and devices repositories for rendering and improving networks-rendered heuristics and logics in said networks.

3. In EM Oracle according to claim 1 wherein said basic collective learning comprises:
said innovative computer programs attached to said networked servers and devices repositories in said networks wherein said innovative computer programs transforming said networked servers and devices repositories into heuristic networked servers and devices repositories in said networks;
a plurality of interactive touch-enabled and touch-responsive scrolling multi-windows in and among said touchscreens and viewing screens wherein a plurality of interactive electronic templates for rendering a plurality of interactive touch-enabled, touch-responsive, expandable, retractable, highlightable scrolling tabs, list, tiles and sub-tiles, folders, files and sub-files, images, icons and videos each of which comprising a plurality of adaptable heuristic compilations of relational data including images and videos henceforth interactive templates wherein each of said compilations comprising interactive touch-enabled, touch-responsive, expandable, retractable, highlightable scrolling comprising a plurality of interactive touch-enabled, touch-responsive, collapsible, expandable and retractable drop-downs and pop-ups comprising interactive touch-enabled, touch-responsive, collapsible, expandable and retractable highlightable rendered heuristics and logics henceforth interactive icons and images;
said interactive icons and images for attaching said apps said apps for activating said innovative computer programs for rendering diverse and different orders and organizations of diverse and different heuristic bits of relational data and relations of heuristic bits of relational data comprising diverse relational field*_n, specialty*_n-, diagnosis*_n-, finding*_n, causation*_n, temporal*_n-, duration*_n- and category*_n- and repository*-identification*_n-specific data endowed with inherent heuristics and logics in diverse and different heuristic compilations of relational data including images and videos being gotten from said rendered heuristics and logics in and among said heuristic networked servers and devices repositories, where henceforth * connotes individual distinct terms, n=1, 2, 3 . . . , very large number;
said diverse and different renderings for rendering and improving said rendered heuristics and logics thus said adaptable abiotic intelligence;
said Thesaurus and heuristics-logics synthesizer associating with said renderings in said touchscreens and viewing screens;
said rendered heuristics and logics for dictating and guiding said diverse and different orders and organizations of diverse and different heuristic bits of relational data and relations of heuristic bits of relational data in HALS;
said plurality of interactive templates for rendering said renderings in and among said heuristic networked servers and devices repositories, said rendered heuristics and logics for dictating and guiding said renderings in and among said diverse and different heuristic compilations of relational data including images and videos in said interactive templates;
said plurality of interactive templates for rendering said renderings and queries in heuristic networked servers and devices repositories, said rendered heuristics and logics for guiding said renderings of queries comprising said bits of relational data and relations of bits of relational data in and among said diverse and different heuristic compilations of relational data including images and videos in said interactive templates;
millions of said networked servers and devices repositories for using and rendering said means for rendering and improving said adaptable abiotic intelligence; and billions of said networked servers and devices repositories for using and rendering said means for rendering and improving said adaptable abiotic intelligence in said networks.

4. In the EM Oracle according to claim 1 wherein HALS comprises:
said innovative computer programs attached to said networked servers and devices repositories;
said touch-enabled and touch-responsive scrolling multi-windows;
said basic collective learning;
the abiotic creator comprising:
a plurality of assortment of interactive touch-enabled, touch-responsive, collapsible, expandable, retractable and highlightable tree traversals in multi-dimensions, each tree traversal comprising a plurality of interactive., touch-enabled, touch-responsive, collapsible, expandable, retractable and highlightable subtrees in multi-dimensions, each subtree comprising rows and columns in 2-dimensions and multi-dimensions and lattices of interactive touch-enabled, touch-responsive-collapsible, expandable, retractable and highlightable roots, nodes, parents and children henceforth interactive tree traversals in and among said touchscreens and viewing screens;
said interactive tree traversals for getting, associating with and displaying relevant and corresponding said rows and columns associating with orders and organizations of diverse and different heuristic compilations of relational data each of which comprises relations of heuristic bits of relational data each of which comprises diverse relational field*_n, specialty*_n-, diagnosis*_n-, finding*_n, causation*_n, temporal*_n-, duration*_n- and category*_n- and repository**-identification*_n-specific data endowed with inherent heuristics and logics being gotten by said processor units from said rendered heuristics and logics to render said associations of said interactive tree traversals and said gotten rendered heuristics and logics relating to relations of heuristic bits of relational data whenever rendered in said means for rendering and improving said adaptable abiotic intelligence in said networks, where henceforth * connotes individual distinct terms, n=1, 2, 3 . . . , very large number;
associations of said Thesaurus and edit functions for editing with said heuristic compilations of relational data;
associations of said edit functions for editing heuristics and logics rendered by said commercial computer programs for editing data and said touch-enabled and touch-responsive bits of relational data in and among pluralities of heuristic compilations of relational data associating with said interactive tree traversals as with said process of said EM Oracle rendering said heuristic networked servers and devices repositories;
queries being rendered in said means for rendering and improving said adaptable abiotic intelligence, said processor units for scanning, analyzing and relating said queries to said rendered heuristics and logics in said memories in and among said heuristic networked servers and devices repositories, said processor units for applying rendered heuristics and logics to identify, mark and get dominant and prevalent heuristics and logics related to said queries in said rendered heuristics and logics
interactive highlights for representing said dominant and prevalent relations and compilations as interactive touch-enabled, touch-responsive, collapsible, expandable, retractable highlighted sub-trees, roots, nodes, parents and children and inter-subtrees, -roots, -nodes, -parents and -children representing coincidences of scanned, analyzed and related individual heuristic bits of relational data, heuristic compilations of relational data and related heuristics and logics in said queries with said same, similar, related and linked rendered heuristics and logics in said memories, said interactive highlights in and among said interactive tree traversals in and among said touchscreens and viewing screens;
heuristics-logics synthesizer for editing and modifying said interactive tree traversals and interactive highlights in and among said touchscreens and viewing screens, said heuristics-logics synthesizer for editing and modifying said pluralities of heuristic compilations of relational data including said dominant and prevalent relations and compilations associating with said interactive tree traversals and interactive highlights, said processor units for editing and modifying said dominant and prevalent relations and compilations in and among said heuristic compilations of relational data-in and among said touchscreens and viewing screens based on the editions and modifications of said heuristic compilations of relational data associating with editions and modifications said interactive tree traversals and interactive highlights being caused by the drag and drop, scroll, undo, cut, copy, paste, delete, find, find next, search, replace, go to, select functions of said heuristics-logics synthesizers;
commercial speech recognition technologies and software for speech recognition comprising said bits of relational data in conjunction, coordination and synchrony with the applications of said functions of said heuristics-logics synthesizer to modify and edit said dominant and prevalent relations and compilations in and among said touchscreens and viewing screens by said processes and to render the networks-rendered real-time conversions between and among said interactive tree traversals and interactive highlights and in said rendered heuristics and logics;
a collaboration of said interactive tree traversals and interactive highlights with a plurality of multi-dimensional continua and sequences of assortment of interactive touch-enabled, touch-responsive, collapsible, expandable, retractable and highlightable electronic interactive icons and images, tabs, list, tiles and sub-tiles, folders, files and sub-files, images, icons and videos in said touchscreens and viewing screens henceforth interactive icons and images, apps for activating said innovative computer programs to render queries in said means for rendering and improving said adaptable abiotic intelligence, said processor units for scanning, analyzing and relating said queries with said rendered heuristics and logics in said memories in and among said heuristic networked servers and devices repositories, said processor units for applying rendered heuristics and logics to identify, mark and get dominant and prevalent heuristics and logics related to said queries in said rendered heuristics and logics, said processor units for displaying highlighted interactive icons and images in and among said multi-dimensional continua and sequences representing coincidences of scanned, analyzed and related individual heuristic bits of relational data, heuristic compilations of relational data and related heuristics and logics in said queries with said same, similar, related and linked rendered heuristics and logics in said memories henceforth interactive highlights;
a touch-enabled and touch-responsive scrolling multi-windows comprising said interactive icons and images;
said Thesaurus and edit functions for editing with said heuristic compilations of relational data; said apps for activating said innovative computer programs to render said interactive icons and images in said touchscreens and viewing screens wherein said interactive icons and images associating and displaying said plurality of interactive touch-enabled and touch-responsive drop-downs and pop-ups of a plurality of interactive touch-enabled and touch-responsive heuristic compilations of relational data;
an association of said heuristics-logics synthesizer with said interactive icons and images and interactive highlights in and among said touchscreens and viewing screens, said heuristics-logics synthesizer to modify said dominant and prevalent relations and compilations associating with said interactive icons and images and interactive highlights, said processor units for modifying and editing said dominant and prevalent relations and compilations in and among said touchscreens and viewing screens based on the editions and modifications of said heuristic compilations of relational data associating with editions and modifications said interactive icons and images and interactive highlights being caused by the drag and drop, scroll, undo, cut, copy, paste, delete, find, find next, search, replace, go to, select functions of said heuristics-logics synthesizers;
commercial speech recognition technologies and software for speech recognition comprising said bits of relational data in conjunction, coordination and synchrony with the applications of said functions of said heuristics-logics synthesizer, said heuristics-logics synthesizer for modifying and editing said dominant and prevalent relations and compilations in and among said touchscreens and viewing screens, said processor units for rendering the networks-rendered real-time conversions between and among said interactive icons and images and interactive highlights and in said rendered heuristics and logics;
said queries rendered in and among said heuristic networked servers and devices repositories, said processor units for scanning, analyzing and relating said queries to same, similar, related or linked rendered heuristics and logics, said processor units for identifying, marking and getting said dominant and prevalent relations and compilations and said processor units for displaying said dominant and prevalent relations and compilations in associations with said interactive tree traversals, interactive tree traversals, interactive icons and images and interactive highlights in and among touchscreens and viewing screens and to be store in said memories; and
said processor units for rendering said stored physical, biological, genetic and chemical interventions, therapeutics and engineerings in said memories targeting said rendered dominant and prevalent heuristics and logics based on said relations of said renderings in said rendered heuristics and logics and said processor units for predicting and extrapolating rendered and stored products, events and sequelae as consequences of said interventions, therapeutics and engineerings in said memories to modify and control fates and to render abiotic selection to revolutionize evolution.

5. In the EM Oracle according to claim 1 wherein said Thesaurus and heuristics-logics synthesizer comprise:
said Thesaurus for serving as the translator of rendered heuristics and logics in and among said heuristic networked servers and devices repositories wherein said Thesaurus for associating with said plurality of interactive drop-downs and pop-ups wherein said plurality of interactive touch-enabled and touch-responsive heuristic compilations of relational data are in languages, images and videos comprehensible and use by and among laypeople and professional people, said Thesaurus for rendering, adapting and expanding rendered heuristics and logics;
the commercial computer programs for rendering functions for editing data to interactive drop-downs and pop-ups in said touchscreens and viewing screens, said commercial computer programs for editing data in and among said interactive drop-downs and pop-ups, said functions comprising drag and drop, scroll, undo, cut, copy, paste, delete, find, find next, search, replace, go to, select all functions for editing heuristics and logics;
said means for substituting and replacing bits of data in, between and among rendered heuristics and logics in said touchscreens and viewing screens and in said adaptable heuristic compilations in said memories, said heuristics-logics synthesizer for synthesizing and editing assortment of plurality of highlights in and among said tree traversals, images, icons and lists representing said relations and compilations as consequences of said coincidences associating with said plurality of assortment of diverse interactive highlightable, touch-enabled and touch-responsive tree traversals and images, icons and lists in and among said touchscreens and viewing screens and in said memories said computer programs for instructing said networked repositories to use said commercial computer programs for editing data comprise drag and drop, scroll, Undo, Cut, Copy, Paste, Delete, Find, Find Next, Search, Replace, Go to, Select All functions in associations with pluralities of adaptable highlighted tree traversals and rows, columns and lattices of continua and sequences of sub-trees, roots, nodes, parents and children in said touchscreens and viewing screens;
said functions for dragging and dropping, undoing, cutting, copying, pasting, deletng, findng, finding next, searchng, replacing, going to, selecting plurality of heuristic bits of relational data and inherent heuristics and logics in and among plurality of heuristic compilations of relational data associating plurality of interactive tree traversals and plurality of adaptable highlighted tree traversals and rows, columns and lattices of continua and sequences of highlighted sub-trees, roots, nodes, parents and children and inter-subtrees, -roots, -nodes, -parents and -children representing coincidences of scanned, analyzed and related individual heuristic bits of relational data, heuristic compilations of relational data and related heuristics and logics in said queries with said same, similar, related and linked rendered heuristics and logics in said memories;
said innovative computer programs for instructing said networked repositories to use commercial speech recognition technologies and software for speech recognizing voice comprising said bits of relational data in conjunction, coordination and synchrony with said applications of said functions of said commercial computer programs for editing data, said conjunction and coordination for adapting and enlarging rendered heuristics and logics based on rendered heuristics and logics to adapt and enlarge said abiotic intelligence and networks;
said heuristics-logics synthesizer for identifying, marking, getting and displaying said renderings in said dominant and prevalent relations and compilations represented by said assortment of said plurality of highlights in and among said tree traversals and images, icons and lists based on rendered heuristics and logics in and among touchscreens and viewing screens and in said adaptable compilations of databases in said memories;
said heuristics-logics synthesizer for endowing individual peculiar orders and organizations of relations of heuristic bits of relational data in and among heuristic compilations of relational data with peculiar inherent heuristics and logics, said processor units for processing said relations and compilations into said adaptable heuristic compilations of relational databases in said memories also known as rendered heuristics and logics in and among said heuristic networked servers and devices repositories;
said heuristics-logics synthesizer for rendering said EM Oracle for modifying and controlling fates; and said heuristics-logics synthesizer for rendering and improving networks-rendered relations of inherent heuristic algorithms and logics inherent in and among said relations of heuristic bits of relational data in and among relations of said heuristic compilations of relational data in the adaptable heuristic compilations of relational databases in said memories also known herein as rendered heuristics and logics.

6. In the EM Oracle according to claim 1 wherein said EM Oracle for modifying and controlling fates comprises:
said means for rendering said networks of heuristic networked servers and devices repositories;
HALS for rendering said collective learning in and among said networks of heuristic networked servers and devices repositories;
said queries rendered in said networks in and among said networks of heuristic networked servers and devices repositories;
said millions of said networked heuristic networked servers and devices repositories; and
said billions of said networked heuristic networked servers and devices repositories,

7. In the EM Oracle for rendering abiotic decisions according to claim 1 wherein said EM Oracle for rendering and guiding physical biological, genetic and chemical interventions, therapeutics find engineerings targeting said dominant and prevalent relations and compilations and for predicting and extrapolating products, events and sequelae as consequences of said interventions, therapeutics and engineerings and for modifying and controlling fates to render abiotic selection to revolutionize evolution, said EM Oracle comprises:
said EM Oracle for rendering and improving networks-rendered relations of inherent heuristic algorithms and logics inherent in and among networks-rendered relations of adaptable heuristic bits of relational data including images and videos in and among adaptable heuristic compilations of relational data including images and videos in the adaptable heuristic compilations of relational databases known herein as and henceforth rendered heuristics and logics in memories in and among said heuristic networked servers and devices repositories;
said basic collective learning;
HALS;
said EM oracle comprising said networks of heuristic networked servers and devices repositories for:
rendering repository*-identification*_n-specific data in said rendered heuristics and logics in said memories based on HALS renderings henceforth rendered repository*-identification*_n-specific heuristics and logics;
identifying, marking, getting and displaying said dominant and prevalent rendered repository*-identification*_n-specific heuristics and logics in said memories and in and among touchscreens and viewing screens;
source heuristics and logics comprising field*_n, specialty*_n-, diagnosis*_n- or finding*_n, causation*_n, temporal*_n-, duration*_n-specific rendered repository*-identification*_n-specific heuristics and logics;
category heuristics and logics comprising category*_n-data*_n, temporal*_-, duration*_n-specific rendered repository*-identification*_n-specific heuristics and logics;
rendering said interventions, therapeutics and engineerings comprise source heuristics and logics-specific category heuristics and logics wherein category*_n-data*; n, temporal*_n-, duration*_n-specific data rendered in said rendered heuristics and logics based on HALS renderings;
rendering a plurality of heuristic relational field*_n, specialty*_n-, diagnosis*_n-, finding*_n, causation*_n, temporal*_n-, duration*_n- and category*_n- and repository*-identification*_-specific data wherein said category*_n comprise said interventions, therapeutics and engineerings relating to heuristic bits of relational data and relations of heuristic bits of relational data associating with said rendered repository*-identification*_n-specific heuristic networked servers and devices repositories;
rendering, marking and displaying said dominant and prevalent relations and compilations whereby said EM Oracle rendering and guiding physical, biological, genetic and chemical interventions, therapeutics and engineerings targeting said dominant and prevalent relations and compilations, said interventions, therapeutics and engineerings are related and associated with products, events and sequelae; and
rendering networks-rendered queries in said HALS based on said rendered heuristics and logics in HALS, said processor units for scanning and analyzing said queries based on said rendered heuristics and logics in said memories, and said processor units rendering, marking and displaying said dominant and prevalent relations and compilations wherein said EM Oracle for rendering and guiding physical, biological, genetic and chemical interventions, therapeutics and engineerings targeting said rendered dominant and prevalent relations and compilations and rendering products, events and sequelae relating or associating with said interventions, therapeutics and engineerings.

8. The process of said EM Oracle predicting and extrapolating products, events and sequelae of said interventions, therapeutics and engineerings comprises processes of utilizing relations heuristic bits of relational data having inherent heuristics and logics peculiar to said queries to get, render, mark and display dominant and prevalent relations and compilations having same, similar, related or linked relations as said peculiar relations to predict and extrapolate products, events and sequelae of said interventions, therapeutics and engineerings rendered by said processes.

9. In the EM Oracle having adaptable abiotic intelligence for rendering abiotic decisions to render abiotic selection in networks according to claim 1, a method of said EM Oracle rendering and improving collective learning being endowed with the adaptable abiotic intelligence based on heuristics and logics, the EM Oracle rendering and improving networks-rendered relations of inherent heuristics and logics inherent in and among networks-rendered relations of adaptable heuristic bits of relational data including images and videos in and among adaptable heuristic compilations of relational data including images and videos in the adaptable heuristic compilations of relational databases herein known as and henceforth rendered heuristics and logics in memories in and among said heuristic networked servers and devices repositories, the Thesaurus, an editing means and heuristics-logics synthesizer rendering and expanding said adaptable abiotic intelligence and networks and improving rendered heuristics and logics to render and improve said collective learning, the EM Oracle rendering said abiotic decisions to identify, mark, get and display dominant and prevalent relations and compilations based on rendered heuristics and logics in and among touchscreens and viewing screens and in said memories and rendering and guiding physical, biological, genetic and chemical interventions, therapeutics and engineerings targeting said dominant and prevalent relations and compilations, predicting and extrapolating the products, events and sequelae as consequences of said interventions, therapeutics and engineerings and modifying and controlling fates to render abiotic selection to revolutionize evolution, said method comprises processes of said EM Oracle rendering:
rendering said heuristic networked servers and devices repositories having networked repositories identifications, said touchscreens and viewing screens, cameras, microphones, speech recognition software and apps, said networked repositories comprising processor units for processing and expanding said rendered heuristics and logics, relations and compilations and said data and networks being instructed and guided by the innovative computer programs and said memories for storing software including said innovative computer programs, software and databases including said rendered heuristics and logics and data, commercial operating systems for managing said networked servers and devices, the Internet, commercial networking means, security means and software including web browsers;
rendering said means for rendering said networks of heuristic networked servers repositories and networked desktops and mobile communication devices repositories henceforth said heuristic networked servers and devices repositories;
said basic collective learning to render and improve said adaptable abiotic intelligence for rendering, abiotic decisions;
said Heuristics Algorithms Locating System known herein as HALS—the collective learning to render and improve said abiotic intelligence in and among said networks of heuristic networked servers and devices repositories;
rendering HALS having said basic collective learning and rendered heuristics and logics creator henceforth the abiotic creator using said Thesaurus and heuristics-logics synthesizer to render and expand said rendered heuristics and logics to render and improve said adaptable abiotic intelligence and networks to improve said collective learning;
rendering said rendered heuristics and logics dictating and guiding the EM Oracle what to and how to render said rendered, heuristics and logics in said means for rendering and improving rendered heuristics and logics and HALS in said touchscreens and viewing screens and in said adaptable heuristic compilations in said memories in and among said heuristic networked servers and devices repositories, said renderings rendering and expanding said collective learning, said abiotic intelligence and said networks;
said rendered heuristics and logics to dictate and guide the EM Oracle to render said bits of relational data and relations of bits of relational data using said means for rendering and improving said adaptable abiotic intelligence in HALS and HALS;
said rendered heuristics and logics dictating and guiding the EM Oracle to render queries comprising bits of relational data and relations of bits of relational data in said means for rendering and improving said adaptable abiotic intelligence;
said rendered heuristics and logics dictating and guiding said processor units to scan, analyze and relate said renderings to said rendered heuristics and logics in said memories in and among said heuristic networked servers and devices repositories and to identify, mark and get dominant and prevalent heuristics and logics In said rendered heuristics and logics to display in said touchscreens and viewing screens, said processor units rendering and guiding said rendered and stored physical, biological, genetic and chemical interventions, therapeutics and engineerings in said memories targeting said rendered dominant and prevalent heuristics and logics based on said relations of said renderings in said rendered heuristics and logics and, simultaneously, to predict and extrapolate rendered and stored products, events and sequelae as consequences of said interventions, therapeutics and engineerings in said memories to modify and control fates and to render abiotic selection to revolutionize evolution;
relational data on said physical, biological, genetic and chemical interventions, therapeutics and engineerings and related products, events and sequelae as consequences and relations and compilations in said rendered heuristics and logics in said databases in said memories;
said innovative computer programs instructing and guiding said hueristic networked repositories to render and implement said heuristic networks, basic collective learning, HALS, Thesaurus, heuristics-logics synthesizer, speech recognition technologies and software, means, databases, abiotic selection and abiotic brain;
said innovative computer programs rendering a plurality of apps, said apps executing said innovative computer programs in and among said networks of heuristic networked servers and devices repositories;
said millions of said networked heuristic servers and devices repositories rendering and executing said processes in said networks; and
said billions of said networked heuristic servers and devices repositories rendering and executing said processes in said networks.

10. The method of said EM Oracle rendering and improving collective learning according to claim 9 wherein said process of said EM Oracle rendering said heuristic networked servers and devices repositories, said process comprises processes of said EM Oracle:
attaching said innovative computer programs to said networked servers and devices repositories in said networks wherein said innovative, computer programs transforming said networked repositories into heuristic networked servers and devices repositories by said computer programs instructing said networked servers and devices repositories to render and improve said rendered heuristics and logics by:
rendering and using said interactive icons and images comprising a plurality of touch-enabled, touch-responsive, expandable, retractable highlightable electronic interactive icons and Images, tabs, list, tiles and sub-tiles, folders, files and sub-files, images, icons and videos herein known as and henceforth interactive icons and images, said apps activating said, innovative computer programs to render said plurality of heuristic relational field*_n, specialty*_n-, diagnosis*_n-, finding*_n, causation*_n, temporal*_n-, duration*_n- and category*_n- and repository*-identification*_n-specific data endowed with inherent heuristics and logics known herein as heuristic compilations of relational data wherein diverse and adaptable relations of said inherent heuristics and logics In and among heuristic compilations of relational data to render and adapt said rendered heuristics and logics are caused by the diverse orders and organizations of said inherent heuristics and logics being rendered in and among said interactive icons and images, said rendered heuristics and logics dictate and guide the subsequent renderings of said heuristic compilations of relational data in said means for rendering and improving said adaptable abiotic intelligence and in HALS;
associating said interactive icons and images with said apps, said apps to activate said innovative computer programs to render said interactive icons and images in said touchscreens and viewing screens wherein said interactive icons and images associating and displaying said plurality of interactive touch-enabled and touch-responsive drop-downs and pop-ups of a plurality of interactive touch-enabled and touch-responsive heuristic compilations of relational data;
rendering said Thesaurus to serve as the translator of said heuristic compilations of relational data in and among said touchscreens and viewing screens wherein said Thesaurus associating with said touch-enabled and touch-responsive heuristic compilations of relational data associating with said interactive drop-downs and pop-ups, said interactive drop-downs and pop-ups comprising a plurality of interactive touch-enabled and touch-responsive relations of heuristic bits of relational data wherein said data are rendered in languages, images and videos comprehensible and use by and among laypeople and professional people, applying said Thesaurus in and among relevant networked servers and devices repositories thereby rendering, adapting and expanding rendered heuristics and logics and networks;
using said commercial computer programs for editing data to render edit functions for editing said heuristics and logics associating with said interactive icons and images, interactive drop-downs and pop-ups and heuristic compilations of relational data to consequently render individual peculiar orders and organizations of diverse and different relations of said heuristic bits of relational data endowing with diverse and different relations of heuristics and logics in and among said heuristic compilations of relational data;
instructing said networked repositories to use commercial speech recognition technologies and software to edit, substitute, replace said bits of relational data in and among said heuristic compilations of relational data in said touchscreens and viewing screens in conjunction, coordination and synchrony with said processes being provided by said means for rendering and improving said adaptable abiotic intelligence;
associating the applications of said means for rendering and improving said adaptable abiotic intelligence with said processes being rendered by said interactive icons and images, interactive drop-downs and pop-ups and heuristic compilations of relational data to render said individual orders and organizations of diverse and different relations of said heuristic bits of relational data endowing with diverse and different relations of heuristics and logics in and among said heuristic compilations of relational data and said processor units scanning and analyzing and relating said rendered heuristics and logics in said adaptable heuristic compilation databases in and among said heuristic networked servers and devices repositories;
applying rendered heuristics and logics to dictate and guide the EM Oracle to render, adapt and improve said rendered heuristics and logics and in said in said interactive drop-downs and pop-ups and in HALS in said touchscreens and viewing screens thereby rendering, adapting and expanding rendered heuristics and logics and networks; and
repeating said processes in and among millions and billions of said networked heuristic servers and devices repositories.

11. In the method according to claim 9 wherein said process for the EM Oracle rendering said basic collective learning, said process comprises processes of:
said innovative computer programs attaching to said networked servers and devices repositories in said networks whereby said innovative computer programs transforming said networked servers and devices repositories into heuristic networked servers and devices repositories in said networks;
rendering a plurality of interactive touch-enabled and touch-responsive scrolling multi-windows in and among said touchscreens and viewing screens wherein a plurality of interactive electronic templates rendering a plurality of Interactive touch-enabled, touch-responsive, expandable, retractable, highlightable scrolling tabs, list, tiles and sub-tiles, folders, files and sub-files, images, icons and videos each of which comprising a plurality of adaptable heuristic compilations of relational data including images find videos henceforth interactive templates wherein each of said compilations comprising interactive touch-enabled, touch-responsive, expandable, retractable, highlightable scrolling comprising a plurality of interactive touch-enabled, touch-responsive, collapsible, expandable and retractable drop-downs and pop-ups comprising interactive touch-enabled, touch-responsive, collapsible, expandable and retractable highlightable rendered heuristics and logics henceforth Interactive icons and images;
attaching said apps to said interactive icons and images, said apps activating said innovative computer programs to render diverse and different orders and organizations of diverse and different heuristic bits of relational data and relations of heuristic bits of relational data comprising diverse relational field*_n, specialty*_n-, diagnosis*_n-, finding*_n, causation*_n, temporal*_n-, duration*_n- and category*_n- and repository*-identification*_n-specific data endowed with inherent heuristics and logics in diverse and different heuristic compilations of relational data including images and videos being gotten from said rendered heuristics and logics in and among said heuristic networked servers and devices repositories, where henceforth * connotes individual distinct terms, n=1, 2, 3 . . . , very large number;
said diverse and different renderings to render and improve said rendered heuristics and logics thus said adaptable abiotic intelligence;
associating said Thesaurus and heuristics-logics synthesizer with said renderings in and among said touchscreens and viewing screens, said Thesaurus and heuristics-logics synthesizer for editing and modifying said heuristic compilations of relational data in said Interactive templates, said heuristic, compilations of relational data being gotten by said processor units from said rendered heuristics and logics in said memories;
said rendered heuristics and logics to dictate and guide said diverse and different orders and organizations of diverse and different heuristic bits of relational data and relations of heuristic bits of relational data in HALS;
said plurality of interactive templates to render said renderings in and among said heuristic networked servers and devices repositories, said rendered heuristics and logics to dictate and guide said renderings in and among said diverse and different heuristic compilations of relational data including images and videos in said interactive templates;
said plurality of interactive templates to render said renderings and queries in and among said heuristic networked servers and devices repositories, said rendered heuristics and logics to guide said renderings of queries comprising said bits of relational data and relations of bits of relational data in and among said diverse and different heuristic compilations of relational data including images and videos in said interactive templates;
said rendered heuristics and logics dictating and guiding said processor units to scan, analyze and relate said renderings to said rendered heuristics and logics in said memories in and among said heuristic networked servers and devices repositories and to identify, mark and get dominant and prevalent heuristics and logics in said rendered heuristics and logics to display in said touchscreens and viewing screens;
millions of said networked servers and devices repositories to render and use basic collective learning; and billions of said networked servers and devices repositories to render and use basic collective learning.

12. In the method according to claim 9 wherein said process for the EM Oracle rendering HALS, said process comprises processes of:
said EM Oracle rendering said heuristic networked servers and devices repositories;
rendering said touch-enabled and touch-responsive scrolling multi-windows;
rendering said basic collective learning to collaborate with the following processes being rendered by said heuristic networked servers and devices repositories being instructed by said innovative computer programs instructing to render said abiotic creator to:
render said plurality of assortment of interactive touch-enabled, touch-responsive, collapsible, expandable, retractable and highlightable tree traversals in multi-dimensions, each tree traversal comprising a plurality of interactive, touch-enabled, touch-responsive, collapsible, expandable, retractable and highlightable subtrees in multi-dimensions, each subtree comprising rows and columns in 2-dimensions and multi-dimensions and lattices of interactive touch-enabled, touch-responsive, collapsible, expandable, retractable and highlightable roots, nodes, parents and children collectively known herein as and henceforth interactive tree traversals in and among said touchscreens and viewing screens;
use said rendered heuristics and logics to dictate said interactive tree traversals get, associate with and display relevant and corresponding said rows and columns associating with orders and organizations of diverse and different heuristic compilations of relational data each of which comprises relations of heuristic bits of relational date each of which comprises diverse relational field*_n, specialty*_n-, diagnosis*_n-, finding*_n, causation*_n, temporal*_n-, duration*_n- and category*_n- and repository**-identification*_n-specific data endowed with inherent, heuristics and logics being gotten by said processor units from said rendered heuristics and logics to render said associations of said interactive tree traversals and said gotten rendered heuristics and logics relating to relations of heuristic bits of relational data whenever rendered in said means for rendering and improving said adaptable abiotic intelligence in said networks, where henceforth * connotes individual distinct terms, n=1, 2, 3 . . . , very large number;
associate said Thesaurus and edit functions for editing with said heuristic compilations of relational data;
associate said edit functions for editing heuristics and logics rendered by said commercial computer programs for editing data with said touch-enabled and touch-responsive heuristic bits of relational data in and among pluralities of heuristic compilations of relational data associating with said interactive tree traversals as with said process of said EM Oracle rendering said heuristic networked servers and devices repositories;
render queries in said means for rendering and improving said adaptable abiotic intelligence and said processor units to scan, analyze and relate said queries to said rendered heuristics and logics in said memories in and among said heuristic networked servers and devices repositories by said processor units applying rendered heuristics and logics to identify, mark and get dominant and prevalent heuristics and logics related to said queries in said rendered heuristics and logics to display as interactive touch-enabled, touch-responsive, collapsible, expandable, retractable highlighted sub-trees, roots, nodes, parents and children and inter-subtrees, -roots, -nodes, -parents and -children henceforth interactive highlights in and among said interactive tree traversals representing coincidences of scanned, analyzed and related individual heuristic bits of relational data, heuristic compilations of relational data and related heuristics and logics in said queries with said same, similar, related and linked rendered heuristics and logics in said memories;
associate said heuristics-logics synthesizer with said interactive tree traversals and interactive highlights in and among said touchscreens and viewing screens, said heuristics-logics synthesizer to modify said dominant and prevalent relations and compilations associating with said interactive tree traversals and interactive highlights by said processor units modifying and editing said dominant and prevalent relations and compilations in and among said touchscreens and viewing screens based on the editions and modifications of said heuristic compilations of relational data associating with editions and modifications said interactive tree traversals and interactive highlights being caused by the drag and drop, scroll, undo, cut, copy, paste, delete, find, find next, search, replace, go to, select functions of said heuristics-logics synthesizers;
use commercial speech recognition technologies and software to speech recognize voice comprising said bits of relational data in conjunction, coordination and synchrony with the applications of said functions of said heuristics-logics synthesizer to modify and edit said dominant and prevalent relations and compilations in and among said touchscreens and viewing screens by said processes and to render the networks-rendered real-time conversions between and among said interactive tree traversals and interactive highlights and in said rendered heuristics and logics;
collaborating with supra, render multi-dimensional continua and sequences of assortment of interactive touch-enabled, touch-responsive, collapsible, expandable, retractable and highlightable electronic interactive icons and images, tabs, list, tiles and sub-tiles, folders, files and sub-files, images, icons and videos in said touchscreens and viewing screens henceforth interactive icons and images, said apps activating said innovative computer programs to render queries in said means for rendering and improving said adaptable abiotic intelligence and said processor units to scan, analyze and relate said queries to said rendered heuristics and logics in said memories in and among said heuristic networked servers and devices repositories by said processor units applying rendered heuristics and logics to identify, mark and get dominant and prevalent heuristics and logics related to said queries in said rendered heuristics and logics to display as highlighted interactive icons and images in and among said multi-dimensional continua and sequences representing coincidences of scanned, analyzed and related individual heuristic bits of relational data, heuristic compilations of relational data and related heuristics and logics in said queries with said same, similar, related and linked rendered heuristics and logics in said memories henceforth interactive highlights;
render a touch-enabled and touch-responsive scrolling multi-windows comprising said interactive icons and images;
associate said Thesaurus and edit functions for editing with said heuristic compilations of relational data;
render said interactive icons and images associating with said apps, said apps to activate said innovative computer programs to render said interactive icons and images in said touchscreens and viewing screens wherein said interactive icons and images associating and displaying said plurality of interactive touch-enabled and touch-responsive drop-downs and pop-ups of a plurality of interactive touch-enabled and touch-responsive heuristic compilations of relational data;
associate said heuristics-logics synthesizer with said interactive icons and images and interactive highlights in and among said touchscreens and viewing screens, said heuristics-logics synthesizer to modify said dominant and prevalent relations and compilations associating with said interactive icons and images and interactive highlights by said processor units modifying and editing said dominant and prevalent relations and compilations in and among said touchscreens and viewing screens based on the editions and modifications of said heuristic compilations of relational data associating with editions and modifications said interactive icons and images and interactive highlights being caused by the drag and drop, scroll, undo, cut, copy, paste, delete, find, find next, search, replace, go to, select functions of said heuristics-logics synthesizers;
use commercial speech recognition technologies and software to speech recognize voice comprising said bits of relational data in conjunction, coordination and synchrony with the applications of said functions of said heuristics-logics synthesizer to modify and edit said dominant and prevalent relations and compilations in and among said touchscreens and viewing screens by said processes and to render the networks-rendered real-time conversions between and among said interactive icons and images and interactive highlights and in said rendered heuristics and logics;
respond to queries whenever said queries are rendered in and among said heuristic networked servers and devices repositories by said processor units scanning, analyzing and relating said queries to same, similar, related or linked rendered heuristics and logics and to identify, mark and get said dominant and prevalent relations and compilations to be displayed in associations with said interactive tree traversals, interactive tree traversals, interactive icons and images and interactive highlights in and among touchscreens and viewing screens and to be store in said memories; and
render and guide by said processor units to render said stored physical, biological, genetic and chemical interventions, therapeutics and engineerings in said memories targeting said rendered dominant and prevalent heuristics and logics based on said relations of said renderings in said rendered heuristics and logics and to predict and extrapolate rendered and stored products, events and sequelae as consequences of said interventions, therapeutics and engineerings in said memories to modify and control fetes and to render abiotic selection to revolutionize evolution;
millions of said networked servers and devices repositories to render and use HALS; and
billions of said networked, servers and devices repositories to render and use HALS.

13. The method of said EM Oracle rendering and improving collective learning according to claim 9 wherein said process of said Thesaurus and heuristics-logics synthesizer to adapt and enlarge said abiotic intelligence and networks, said process comprises processes of said computer programs instructing said networked repositories to:
render said Thesaurus to serve as the translator of said heuristic compilations of relational data in and among said touchscreens and viewing screens wherein said Thesaurus associating with said touch-enabled and touch-responsive heuristic compilations of relational data associating with said interactive drop-downs and pop-ups, said interactive drop-downs and pop-ups comprising a plurality of interactive touch-enabled and touch-responsive relations of heuristic bits of relational data wherein said data are rendered in languages, images and videos comprehensible and use by and among laypeople and professional people, applying said Thesaurus in and among relevant networked servers and devices repositories thereby rendering, adapting and expanding rendered heuristics and logics and networks;
use said commercial computer programs for editing data comprise drag and drop, scroll, Undo, Cut, Copy, Paste, Delete, Find, Find Next, Search, Replace, Go to, Select All functions in associations with pluralities of adaptable tree traversals and highlighted tree traversals and rows, columns and lattices of continua and sequences of sub-trees, roots, nodes, parents and children in said touchscreens and viewing screens;
use said functions for dragging and dropping, undoing, cutting, copying, pasting, deletng, findng, findng next, searchng, replacing, going to, selecting plurality of heuristic bits of relational data and inherent heuristics and logics in and among plurality of heuristic compilations of relational data associating plurality of interactive tree traversals and plurality of adaptable highlighted tree traversals and rows, columns and lattices of continua and sequences of highlighted sub-trees, roots, nodes, parents and children and inter-subtrees, -roots, -nodes, -parents and -children representing coincidences of scanned, analyzed and related individual heuristic bits of relational data, heuristic compilations of relational data and related heuristics and logics in said queries with said same, similar, related and linked rendered heuristics and logics in said memories;
use said heuristics-logics synthesizer endowing individual peculiar orders and organizations of relations of heuristic bits of relational data In and among heuristic compilations of relational data with peculiar inherent heuristics and logics, said processor units processing said relations and compilations into said adaptable heuristic compilations of relational databases in said memories also known as rendered heuristics and logics in and among said heuristic networked servers and devices repositories: and
use said heuristics-logics synthesizer for identifying, marking, getting and displaying said renderings in said dominant and prevalent heuristics and logics represented by said assortment of said plurality of highlights in and among said tree traversals and images, icons and lists based on rendered heuristics and logics in and among touchscreens and viewing screens and in said adaptable compilations of databases in said memories.

14. The method of said EM Oracle rendering and improving collective learning according to claim 9 wherein said process of said EM Oracle rendering and guiding physical, biological, genetic and chemical interventions, therapeutics and engineerings targeting said dominant and prevalent relations and compilations, predicting and extrapolating the products, events and sequelae as consequences of said interventions, therapeutics and engineerings and modifying raid controlling fates to render abiotic selection to revolutionize evolution, said process comprises processes of said EM Oracle:
rendering and improving networks-rendered relations of inherent heuristic algorithms and logics inherent in and among networks-rendered relations of adaptable heuristic bits of relational data including images and videos in and among adaptable heuristic compilations of relational data including images and videos in the adaptable heuristic compilations of relational databases known herein as and henceforth rendered heuristics and logics in memories in and among said heuristic networked servers and devices repositories;
rendering relational data on said physical, biological, genetic and chemical interventions, therapeutics and engineerings and related products, events and sequelae as consequences and relations and compilations in said rendered heuristics and logics in said databases in said memories;
having said means for rendering and improving said adaptable abiotic intelligence;
rendering said heuristics and logics by rendered by HALS;
rendering repository*-identification*_n-specific data in said rendered heuristics and logics in said memories based on HALS renderings henceforth rendered repository*-identification*_n-specific heuristics and logics;
identifying, marking and getting said dominant and prevalent rendered repository*-identification*_n-specific heuristics and logics in said memories and displaying in and among touchscreens and viewing screens;
rendering said source heuristics and logics comprising field*_n, specialty*_n-, diagnosis*_n- or finding*_n, causation*_n, temporal*_n-, duration*_n-specific rendered repository*-identification*_n-specific heuristics and logics;
rendering said category heuristics and logics comprising category*_n-data*_n, temporal*_n-, duration*_n-specific rendered repository*-identification*_n-specific heuristics and logics;
rendering said interventions, therapeutics and engineerings comprise source heuristics and logics-specific category heuristics and logics wherein category*_n-data*_n, temporal*_n-, duration*_n-specific data rendered in said rendered heuristics and logics based on HALS renderings;
rendering a plurality of heuristic relational field*_n, specialty*_n-, diagnosis*_n-, finding*_n, causation*_n, temporal*_n-, duration*_n- and category*_n- and repository*-identification*_n-specific data wherein said category*_n comprise said interventions, therapeutics and engineerings relating to heuristic bits of relational data and relations of heuristic bits of relational data associating with said rendered repository*-identification*_n-specific heuristic networked servers and devices repositories;
rendering, marking and displaying said dominant and prevalent relations and compilations whereby said EM Oracle rendering and guiding physical, biological, genetic and chemical interventions, therapeutics and engineerings targeting said dominant and prevalent relations and compilations, said interventions, therapeutics and engineerings are related and associated with products, events and sequelae; and
rendering networks-rendered queries using said HALS based on said rendered heuristics and logics in HALS, said processor units scanning and analyzing said queries based on said rendered heuristics and logics in said memories to render, mark and display said dominant and prevalent relations and compilations whereby said EM Oracle rendering and guiding physical, biological, genetic and chemical interventions, therapeutics and engineerings targeting said rendered dominant and prevalent relations and compilations and predicting and extrapolating products, events and sequelae of said interventions, therapeutics and engineerings.

15. The process of said EM Oracle predicting and extrapolating products, events and sequelae of said interventions, therapeutics and engineerings according to claim 9 comprises processes of utilizing relations heuristic bits of relational data having inherent heuristics and logics peculiar to said queries to get, render, mark and display dominant and prevalent relations and compilations having same, similar, related or linked relations as said peculiar relations to predict and extrapolate products, events and sequelae of said interventions, therapeutics and engineerings rendered by said processes.

16. In the EM Oracle according to claim 1, a method of rendering abiotic selection to modify and control fates and to revolutionize evolution, said method comprises processes of said EM Oracle:
rendering said heuristic networked servers and devices repositories having networked repositories identifications, said touchscreens and viewing screens, cameras, microphones, speech recognition software and apps, said networked repositories comprising processor units for processing and expanding said rendered heuristics and logics, relations and compilations and said data and networks being instructed and guided by the innovative computer programs and said memories for storing software including said innovative computer programs, software and databases including said rendered heuristics and logics and data, commercial operating systems for managing said networked servers and devices, the Internet, commercial networking means, security means and software including web browsers;
rendering said heuristic networked servers and devices repositories having networked repositories identifications, said touchscreens and viewing screens, cameras, microphones, speech recognition software and apps, said networked repositories comprising processor units for processing and expanding said rendered heuristics and logics, relations and compilations and said data and networks being instructed and guided by the innovative computer programs and said memories for storing software including said innovative computer programs, software and databases including said rendered heuristics and logics and data, commercial operating systems for managing said networked servers and devices, the Internet, commercial networking means, security means and software including web browsers;
rendering said means for rendering said networks of heuristic networked servers repositories and networked desktops and mobile communication devices repositories henceforth said heuristic networked servers and devices repositories;
rendering said basic collective learning;
rendering HALS the collective learning, HALS having said basic collective learning and rendered heuristics and logics creator henceforth the abiotic creator using said Thesaurus and heuristics-logics synthesizer to render and expand said rendered heuristics and logics to render and improve said adaptable abiotic intelligence and networks to improve said collective learning;
rendering said relations of bits of data and relations of bits of relational data in said means for rendering and improving said adaptable abiotic intelligence in said touchscreens and viewing screens;
rendering queries comprising bits of data and bits of relational data in said means for rendering and improving said adaptable abiotic intelligence, said queries for rendering and expanding said collective learning and said networks;
rendering and improving said rendered heuristics and logics in means for rendering and improving said adaptable abiotic intelligence and said rendered heuristics and logics in said memories in and among said heuristic networked servers and devices repositories to render and expand said collective learning and said networks by repeatedly utilizing said means for rendering and improving said adaptable abiotic intelligence in and among said heuristic networked servers and devices repositories;
using said rendered heuristics and logics to instruct and guide said processor units how to process said queries and to identify, mark, get and display dominant and prevalent heuristics and logics based on data in said processed queries and rendered heuristics and logics in and among said touchscreens and viewing screenings and in said memories;
rendering relational data on said physical, biological, genetic and chemical interventions, therapeutics and engineerings and related products, events and sequelae as consequences and relations and compilations in said rendered heuristics and logics in said databases in said memories;
rendering and guiding said physical, biological, genetic and chemical interventions, therapeutics and engineerings targeting said dominant and prevalent heuristics and logics and predicting and extrapolating the products, events and sequelae as consequences of said interventions, therapeutics and engineerings and modifying and controlling fates to render abiotic selection to revolutionize evolution;
said innovative computer programs instructing and guiding said hueristic networked repositories to render and implement said heuristic networks, HALS, Thesaurus, software for editing data, heuristics-logics synthesizer, speech recognition technologies and software, databases, means, abiotic selection and abiotic brain;
said innovative computer programs rendering a plurality of apps, said apps executing said innovative computer programs In and among said networks of heuristic networked servers and devices repositories;
millions of said networked heuristic servers and devices repositories rendering and executing said processes in said networks; and
billions of said networked heuristic servers and devices repositories rendering and executing said processes in said networks.

17. In the method according to claim 16 wherein said process of said EM Oracle rendering said HALS having said basic learning, said process comprises processes of:
learning to render adaptable abiotic intelligence by rendering and improving HALS to render improve rendered heuristics and logics to render and improve collective learning, said HALS comprising processes of rendering:
said process of said EM Oracle rendering said heuristic networked servers and devices repositories;
said touch-enabled and touch-responsive scrolling multi-windows;
said basic learning collaborating with HALS, HALS rendering said basic collective learning and said abiotic creator having the following processes of:
rendering said plurality of assortment of interactive touch-enabled, touch-responsive, collapsible, expandable, retractable and highlightable tree traversals in multi-dimensions, each tree traversal comprising a plurality of interactive, touch-enabled, touch-responsive, collapsible, expandable, retractable and highlightable subtrees in multi-dimensions, each subtree comprising rows and columns in 2-dimensions and multi-dimensions and lattices of interactive touch-enabled, touch-responsive, collapsible, expandable, retractable and highlightable roots, nodes, parents and children collectively known herein as and henceforth interactive tree traversals in and among said touchscreens and viewing screens;
using said rendered heuristics and logics to dictate said interactive tree traversals get, associate with and display relevant and corresponding Said rows and columns associating with orders and organizations of diverse and different heuristic compilations of relational data-each of which comprises relations of heuristic bits of relational data each of which comprises diverse relational field*_n, specialty*_n-, diagnosis*_n-, finding*_n, causation*_n, temporal*_n-, duration*_n- and category*_n- and repository**-identification*_n-specific data endowed with inherent heuristics and logics being gotten by said processor units from said rendered heuristics and logics to render said associations of said interactive tree traversals and said gotten rendered heuristics and logics relating to relations of heuristic bits of relational data whenever rendered in said means for rendering and improving said adaptable abiotic intelligence in said networks, where henceforth * connotes individual distinct terms, n=1, 2, 3 . . . , very large number;
associating said Thesaurus and edit functions for editing with said heuristic compilations of relational data;
associating said edit functions for editing heuristics and logics rendered by said commercial computer programs for editing data with said touch-enabled and touch-responsive heuristic bits of relational data in and among pluralities of heuristic compilations of relational data associating with said interactive tree traversals as with said process of said EM Oracle rendering said heuristic networked servers and devices repositories;
rendering queries in said means for rendering and improving said adaptable abiotic intelligence and said processor units to scan, analyze and relate said queries to said rendered heuristics and logics in said memories in and among said heuristic networked servers and devices repositories; by said processor units applying rendered heuristics and logics to identify, mark and get dominant and prevalent heuristics and logics related to said queries in said rendered heuristics and logics to display as interactive touch-enabled, touch-responsive, collapsible, expandable, retractable highlighted sub-trees, roots, nodes, parents and children and inter-subtrees, -roots, -nodes, -parents and -children henceforth interactive highlights in and among said interactive tree traversals representing coincidences of scanned, analyzed and related individual heuristic bits of relational data, heuristic compilations of relational data and related heuristics and logics in said queries with said same, similar, related and linked rendered heuristics and logics in said memories;
associating said heuristics-logics synthesizer with said interactive tree traversals and interactive highlights in and among said touchscreens and viewing screens, said heuristics-logics synthesizer to modify said dominant and prevalent relations and compilations associating with said interactive tree traversals and interactive highlights by said processor units modifying and editing said dominant and prevalent relations and compilations in and among said touchscreens and viewing screens based on the editions and modifications of said heuristic compilations of relational data associating with editions and modifications said interactive tree traversals and interactive highlights being caused by the drag and drop, scroll, undo, cut, copy, paste, delete, find, find next, search, replace, go to, select functions of said heuristics-logics synthesizers;
using commercial speech recognition technologies and software to speech recognize voice comprising said bits of relational data in conjunction, coordination and synchrony with the applications of said functions of said heuristics-logics synthesizer to modify and edit said dominant and prevalent relations and compilations in and among said touchscreens and viewing screens by said processes and to render the networks-rendered real-time conversions between and among said interactive tree traversals and interactive highlights and in said rendered heuristics and logics;
collaborating with supra, render multi-dimensional continua and sequences of assortment of interactive touch-enabled, touch-responsive, collapsible, expandable, retractable and highlightable electronic interactive icons and images, tabs, list, tiles and sub-tiles, folders, files and sub-files, images, icons and videos in said touchscreens and viewing screens henceforth interactive icons and images, said apps activating said innovative computer programs to render queries in said means for rendering and improving said adaptable abiotic intelligence and said processor units to scan, analyze and relate said queries to said rendered heuristics and logics in said memories in and among said heuristic networked servers and devices repositories by said processor units applying rendered heuristics and logics to identify, mark and get dominant and prevalent heuristics and logics related to said queries in said rendered heuristics and logics to display as highlighted interactive icons and images in and among said multi-dimensional continua and sequences representing coincidences of scanned, analyzed and related individual heuristic bits of relational data, heuristic compilations of relational data and related heuristics and logics in said queries with said same, similar, related and linked rendered heuristics and logics in said memories henceforth interactive highlights;
rendering a touch-enabled and touch-responsive scrolling multi-windows comprising said interactive icons and images;
associating said Thesaurus and edit functions for editing with said heuristic compilations of relational data;
rendering said interactive icons and images associating with said apps, said apps to activate said innovative computer programs to render said interactive icons and images in said touchscreens and viewing screens wherein said interactive icons and images associating and displaying said plurality of interactive touch-enabled and touch-responsive drop-downs and pop-ups of a plurality of interactive touch-enabled and touch-responsive heuristic compilations of relational data;
associating said heuristics-logics synthesizer with said interactive icons and images and interactive highlights in and among said touchscreens and viewing screens, said heuristics-logics synthesizer to modify said dominant and prevalent relations and compilations associating with said interactive icons and images and interactive highlights by said processor units modifying and editing said dominant and prevalent relations and compilations in and among said touchscreens and viewing screens based on the editions and modifications of said heuristic compilations of relational data associating with editions and modifications said interactive icons and images and interactive highlights being caused by the drag and drop, scroll, undo, cut, copy, paste, delete, find, find next, search, replace, go to, select functions of said heuristics-logics synthesizers;
using commercial speech recognition technologies and software to speech recognize voice comprising said bits of relational data in conjunction, coordination and synchrony with the applications of said functions of said heuristics-logics synthesizer to modify and edit said dominant and prevalent relations and compilations in and among said touchscreens and viewing screens by said processes and to render the networks-rendered real-time conversions, between and among said interactive icons and images and interactive highlights and in said rendered heuristics and logics;
responding to queries whenever said queries are rendered in and among said heuristic networked servers and devices repositories by said processor units scanning, analyzing and relating said queries to same, similar, related or linked rendered heuristics and logics and to identify, mark and get said dominant and prevalent relations and compilations to be displayed in associations with said Interactive tree traversals, interactive tree traversals, interactive icons and images and interactive highlights in and among touchscreens and viewing screens and to be store in said memories; and
rendering and guiding by said processor units to render said stored physical, biological, genetic and chemical interventions, therapeutics and engineerings in said memories targeting said rendered dominant and prevalent heuristics and logics based on said relations of said renderings in said rendered heuristics and logics and to predict and extrapolate rendered and stored products, events and sequelae as consequences of said interventions, therapeutics and engineerings in said memories to modify and control fates and to render abiotic selection to revolutionize evolution.

18. The method of said EM Oracle rendering and improving collective learning according to claim 9 wherein said process of said Thesaurus and heuristics-logics synthesizer to adapt and enlarge said abiotic intelligence and networks, said process comprises processes of said computer programs instructing said heuristic networked repositories to:
render said Thesaurus to serve as the translator of said heuristic compilations of relational data in and among said touchscreens and viewing screens wherein said Thesaurus associating with said touch-enabled and touch-responsive, heuristic compilations of relational data associating with said interactive drop-downs and pop-ups, said interactive drop-downs and pop-ups comprising a plurality of interactive touch-enabled and touch-responsive relations of heuristic bits of relational data wherein said data are rendered in languages, images and videos comprehensible and use by and among laypeople and professional people, applying said Thesaurus in and among relevant networked servers and devices repositories thereby rendering, adapting and expanding rendered heuristics and logics and networks;
use said commercial computer programs for editing data comprise drag and drop, scroll, Undo, Cut, Copy, Paste, Delete, Find, Find Next, Search, Replace, Go to, Select All functions in associations with pluralities of adaptable tree traversals and highlighted, tree traversals and rows, columns and lattices of continua and sequences of sub-trees, roots, nodes, parents and children in said touchscreens and viewing screens;
use said functions for dragging and dropping, undoing, cutting, copying, pasting, deleting, finding, finding next, searching, replacing, going to, selecting plurality of heuristic bits of relational data and inherent heuristics and logics in and among plurality of heuristic of relational data associating plurality of interactive tree traversals and plurality of adaptable highlighted tree traversals and rows, columns and lattices of continua and sequences of highlighted sub-trees, roots, nodes, parents and children and inter-subtrees, -roots, -nodes, -parents and -children representing coincidences of scanned, analyzed and related individual heuristic bits of relational data, heuristic compilations of relational data and related heuristics and logics in said queries with said same, similar, related and linked rendered heuristics and logics in said memories;
use said heuristics-logics synthesizer endowing individual peculiar orders and organizations of relations of heuristic bits of relational data in and among heuristic compilations of relational data with peculiar inherent heuristics and logics, said processor units processing said relations and compilations into said adaptable heuristic compilations of relational databases in said memories also known as rendered heuristics and logics in and among said heuristic networked servers and devices repositories; and
use said heuristics-logics synthesizer for identifying, marking, getting and displaying said renderings in said dominant and prevalent heuristics and logics represented by said assortment of said plurality of highlights in and among said tree traversals and images, icons and lists based on rendered heuristics and logics in and among touchscreens and viewing screens and in said adaptable compilations of databases in said memories.

19. The method according to claim 15 wherein said process of EM Oracle rendering and guiding said physical, biological, genetic and chemical interventions, therapeutics and engineerings targeting said dominant and prevalent heuristics and logics and predicting and extrapolating the products, events and sequelae as consequences of said interventions, therapeutics and engineerings and modifying and controlling fates to render abiotic selection to revolutionize evolution, said process comprises processes of said EM Oracle:
rendering and improving networks-rendered relations of inherent heuristic algorithms and logics inherent in and among networks-rendered relations of adaptable heuristic bits of relational data including images and videos in and among adaptable heuristic compilations of relational data including images and videos in the adaptable heuristic compilations of relational databases known herein as and henceforth rendered heuristics and logics in memories in and among said heuristic networked servers and devices repositories;
having said basic collective learning;
rendering HALS;
rendering repository*-identification*_n-specific data in said rendered heuristics and logics in said memories based on HALS renderings henceforth rendered repository*-identification*_n-specific heuristics and logics;
identifying, marking and getting said dominant and prevalent rendered repository*-identification*_n-specific heuristics and logics in said memories and displaying in and among touchscreens and viewing screens;
rendering said source heuristics and logics comprising field*_n, specialty*_n-, diagnosis*_n- or finding*_n, causation*_n, temporal*_n-, duration*_n-specific rendered repository*-identification*_n-specific heuristics and logics;
rendering said category heuristics and logics comprising category*_n-data*_n, temporal*_n-, duration*_n-specific rendered repository*-identification*_n-specific heuristics and logics;
rendering said interventions, therapeutics and engineerings comprise source heuristics and logics-specific category heuristics and logics wherein category*_n-data*_n, temporal*_n-, duration*_n-specific data rendered in said rendered heuristics and logics based on HALS renderings;
rendering a plurality of heuristic relational field*_n, specialty*_n-, diagnosis*_n-, finding*_n, causation*_n, temporal*_n-, duration*_- and category*_n- and repository*-identification*_-specific data wherein said category*_n comprise said interventions, therapeutics and engineerings relating to heuristic bits of relational data and relations of heuristic bits of relational data associating with said rendered repository*-identification*_n-specific heuristic networked servers and devices repositories;
rendering, marking and displaying said dominant and prevalent relations and compilations whereby said EM Oracle rendering and guiding physical, biological, genetic and chemical interventions, therapeutics and engineerings targeting said dominant and prevalent relations and compilations, said interventions, therapeutics and engineerings are related and associated with products, events and sequelae; and
rendering networks-rendered queries using said HALS based on said rendered heuristics and logics in HALS, said processor units scanning and analyzing said queries based on said rendered heuristics and logics in said memories to render, mark and display said dominant and prevalent relations and compilations whereby said EM Oracle rendering and guiding physical, biological, genetic and chemical interventions, therapeutics and engineerings targeting said rendered dominant and prevalent relations and compilations and predicting and extrapolating products, events and sequelae of said interventions, therapeutics and engineerings.

20. The process of said EM Oracle predicting and extrapolating products, events and sequelae of said interventions, therapeutics and engineerings according to claim 16 comprises processes of utilizing relations heuristic bits of relational data having inherent heuristics and logics peculiar to said queries to get, render, mark and display dominant and prevalent relations and compilations having same, similar, related or linked relations as said peculiar relations to predict and extrapolate products, events and sequelae of said interventions, therapeutics and engineerings rendered by said processes.
